(19) United States
(12) Patent Application Publication
(10) Pub. No.: US 2026/0135600 A1
(43) Pub. Date: May 14, 2026

(54) SYNTHESIZED SYNCHRONIZATION SYSTEM BLOCK BEAMS

(71) Applicant: QUALCOMM Incorporated, San Diego, CA (US)

(72) Inventors: Ahmed ELSHAFIE, San Diego, CA (US); Alexandros MANOLAKOS, Athens (GR); Hung Dinh LY, San Diego, CA (US)

(21) Appl. No.: 18/699,566

(22) PCT Filed: Nov. 17, 2022
(86) PCT No.: PCT/US2022/080050

§ 371 Date: Apr. 8, 2024

(30) Foreign Application Priority Data
Dec. 22, 2021 (GR) 20210100905

(51) Int. Cl. H04B 7/06

(52) U.S. Cl. CPC H04B 7/06952; H04B 7/0639

(57) ABSTRACT

Methods, systems, and devices for wireless communication are described. A user equipment (UE) may receive, from a base station, a plurality of synchronization signal blocks over a plurality of transmission beams. The UE may determine one or more virtual transmission beams based on corresponding combinations of individual ones of the plurality of transmission beams. The UE may select one or more candidate transmission beams for communications between the base station and the UE, the one or more candidate transmission beams being selected from the plurality of transmission beams and the one or more virtual transmission beams. The UE may transmit, to the base station, an indication of the one or more candidate transmission beams.

### CROSS REFERENCES

The present application is a 371 national stage filing of International PCT Application No. PCT/US2022/080050 by ELSHAFIE et al., entitled “SYNTHESIZED SYNCHRONIZATION SYSTEM BLOCK BEAMS,” filed Nov. 17, 2022; and claims priority to Greek patent application No. 20210100905 by ELSHAFIE et al., entitled “SYNTHESIZED SYNCHRONIZATION SYSTEM BLOCK BEAMS,” filed Dec. 22, 2021, each of which is assigned to the assignee hereof, and each of which is expressly incorporated by reference in its entirety herein.

### FIELD OF TECHNOLOGY

The following relates to wireless communication, including synthesized synchronization signal block (SSB) beams.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications systems, a UE may receive one or more synchronization signal blocks (SSBs) over one or more transmission beams for use in communications (e.g., initial cell searching). However, improvements may be made in provisioning and selection of SSB beams for UEs.

### SUMMARY

The described techniques relate to improved methods, systems, devices, and apparatuses that support synthesized synchronization signal block (SSB) beams. Generally, the described techniques provide for derivation of virtual transmission beams for inclusion in a beam selection process. For example, a user equipment (UE) may receive one or more SSBs over one or more transmission beams, and the UE may derive or determine one or more virtual beams based on the one or more transmission beams. The UE may select from the one or more transmission beams, the one or more derived or determined virtual beams, or both, to determine one or more candidate beams and then transmit an indication of the one or more candidate beams to another device (e.g., a base station).

A method for wireless communication at a user equipment (UE) is described. The method may include receiving, from a base station, a set of multiple synchronization signal blocks over a set of multiple transmission beams, determining one or more virtual transmission beams based on corresponding combinations of individual ones of the set of multiple transmission beams, selecting one or more candidate transmission beams for communications between the base station and the UE, the one or more candidate transmission beams being selected from the set of multiple transmission beams and the one or more virtual transmission beams, and transmitting, to the base station, an indication of the one or more candidate transmission beams.

An apparatus for wireless communication at a UE is described. The apparatus may include a processor, memory coupled with the processor, and instructions stored in the memory. The instructions may be executable by the processor to cause the apparatus to receive, from a base station, a set of multiple synchronization signal blocks over a set of multiple transmission beams, determine one or more virtual transmission beams based on corresponding combinations of individual ones of the set of multiple transmission beams, select one or more candidate transmission beams for communications between the base station and the UE, the one or more candidate transmission beams being selected from the set of multiple transmission beams and the one or more virtual transmission beams, and transmit, to the base station, an indication of the one or more candidate transmission beams.

Another apparatus for wireless communication at a UE is described. The apparatus may include means for receiving, from a base station, a set of multiple synchronization signal blocks over a set of multiple transmission beams, means for determining one or more virtual transmission beams based on corresponding combinations of individual ones of the set of multiple transmission beams, means for selecting one or more candidate transmission beams for communications between the base station and the UE, the one or more candidate transmission beams being selected from the set of multiple transmission beams and the one or more virtual transmission beams, and means for transmitting, to the base station, an indication of the one or more candidate transmission beams.

A non-transitory computer-readable medium storing code for wireless communication at a UE is described. The code may include instructions executable by a processor to receive, from a base station, a set of multiple synchronization signal blocks over a set of multiple transmission beams, determine one or more virtual transmission beams based on corresponding combinations of individual ones of the set of multiple transmission beams, select one or more candidate transmission beams for communications between the base station and the UE, the one or more candidate transmission beams being selected from the set of multiple transmission beams and the one or more virtual transmission beams, and transmit, to the base station, an indication of the one or more candidate transmission beams.

Some examples of the method, apparatuses, and non-transitory computer-readable medium described herein may further include operations, features, means, or instructions for transmitting, to the base station, an indication of one or more virtual transmission beam indices corresponding to the one or more virtual transmission beams based on one or more indices of the individual ones of the set of multiple transmission beams.

Some examples of the method, apparatuses, and non-transitory computer-readable medium described herein may further include operations, features, means, or instructions for receiving, from the base station, an indication of a set of multiple precoding matrix indicators associated with the set of multiple transmission beams and determining the one or more virtual transmission beams based on the set of multiple precoding matrix indicators.

Some examples of the method, apparatuses, and non-transitory computer-readable medium described herein may further include operations, features, means, or instructions for determining one or more channel quality metrics associated with the set of multiple transmission beams and the one or more virtual transmission beams, where selecting the one or more candidate transmission beams may be based on the one or more channel quality metrics, ranking the one or more candidate transmission beams based on the one or more channel quality metrics, and transmitting the indication of the one or more candidate transmission beams based at least in part on the ranking.

Some examples of the method, apparatuses, and non-transitory computer-readable medium described herein may further include operations, features, means, or instructions for receiving, from the base station, an indication of one or more precoding matrix indicator values associated with a transmission beam selected from the one or more candidate transmission beams.

Some examples of the method, apparatuses, and non-transitory computer-readable medium described herein may further include operations, features, means, or instructions for transmitting, to the base station, an indication of a physical layer security key generated based on the indication of the one or more precoding matrix indicator values.

Some examples of the method, apparatuses, and non-transitory computer-readable medium described herein may further include operations, features, means, or instructions for receiving an updated indication of the one or more precoding matrix indicator values.

Some examples of the method, apparatuses, and non-transitory computer-readable medium described herein may further include operations, features, means, or instructions for receiving, from the base station, an indication of one or more identifiers associated with the one or more virtual transmission beams and receiving, from the base station, one or more configurations based on the one or more identifiers.

In some examples of the method, apparatuses, and non-transitory computer-readable medium described herein, the set of multiple synchronization signal blocks may be configured based on a frequency range in which the set of multiple synchronization signal blocks may be transmitted.

Some examples of the method, apparatuses, and non-transitory computer-readable medium described herein may further include operations, features, means, or instructions for receiving, from the base station, control signaling instructing the UE to determine the one or more virtual transmission beams.

A method for wireless communication at a base station is described. The method may include transmitting, to a UE, a set of multiple synchronization signal blocks over a corresponding set of multiple transmission beams, receiving, from the UE, an indication of one or more candidate transmission beams for communications between the base station and the UE, where the one or more candidate transmission beams include one or more virtual transmission beams that represent combinations of individual ones of the set of multiple transmission beams, selecting a transmission beam from the one or more candidate transmission beams, and transmitting downlink data to the UE over the transmission beam.

An apparatus for wireless communication at a base station is described. The apparatus may include a processor, memory coupled with the processor, and instructions stored in the memory. The instructions may be executable by the processor to cause the apparatus to transmit, to a UE, a set of multiple synchronization signal blocks over a corresponding set of multiple transmission beams, receive, from the UE, an indication of one or more candidate transmission beams for communications between the base station and the UE, where the one or more candidate transmission beams include one or more virtual transmission beams that represent combinations of individual ones of the set of multiple transmission beams, select a transmission beam from the one or more candidate transmission beams, and transmit downlink data to the UE over the transmission beam.

Another apparatus for wireless communication at a base station is described. The apparatus may include means for transmitting, to a UE, a set of multiple synchronization signal blocks over a corresponding set of multiple transmission beams, means for receiving, from the UE, an indication of one or more candidate transmission beams for communications between the base station and the UE, where the one or more candidate transmission beams include one or more virtual transmission beams that represent combinations of individual ones of the set of multiple transmission beams, means for selecting a transmission beam from the one or more candidate transmission beams, and means for transmitting downlink data to the UE over the transmission beam.

A non-transitory computer-readable medium storing code for wireless communication at a base station is described. The code may include instructions executable by a processor to transmit, to a UE, a set of multiple synchronization signal blocks over a corresponding set of multiple transmission beams, receive, from the UE, an indication of one or more candidate transmission beams for communications between the base station and the UE, where the one or more candidate transmission beams include one or more virtual transmission beams that represent combinations of individual ones of the set of multiple transmission beams, select a transmission beam from the one or more candidate transmission beams, and transmit downlink data to the UE over the transmission beam.

Some examples of the method, apparatuses, and non-transitory computer-readable medium described herein may further include operations, features, means, or instructions for receiving, from the UE, an indication of one or more virtual transmission beam indices corresponding to the one or more virtual transmission beams based on one or more indices of the individual ones of the set of multiple transmission beams.

Some examples of the method, apparatuses, and non-transitory computer-readable medium described herein may further include operations, features, means, or instructions for transmitting, to the UE, an indication of a set of multiple precoding matrix indicators associated with the set of multiple transmission beams.

In some examples of the method, apparatuses, and non-transitory computer-readable medium described herein, the indication of the one or more candidate transmission beams includes a ranking of the one or more candidate transmission beams.

Some examples of the method, apparatuses, and non-transitory computer-readable medium described herein may further include operations, features, means, or instructions for selecting the transmission beam from the one or more candidate transmission beams based on one or more channel quality metrics associated with the one or more candidate transmission beams and transmitting, to the UE, an indication of one or more precoding matrix indicator values associated with the selected transmission beam.

Some examples of the method, apparatuses, and non-transitory computer-readable medium described herein may further include operations, features, means, or instructions for receiving, from the UE, an indication of a physical layer security key generated based on the indication of the one or more precoding matrix indicator values.

Some examples of the method, apparatuses, and non-transitory computer-readable medium described herein may further include operations, features, means, or instructions for transmitting, to the UE, an updated indication of the one or more precoding matrix indicator values based on a change in the one or more channel quality metrics.

Some examples of the method, apparatuses, and non-transitory computer-readable medium described herein may further include operations, features, means, or instructions for transmitting, to the UE, an indication of one or more identifiers associated with the one or more virtual transmission beams and transmitting, to the UE, one or more configurations based on the one or more identifiers.

Some examples of the method, apparatuses, and non-transitory computer-readable medium described herein may further include operations, features, means, or instructions for configuring the set of multiple synchronization signal blocks based on a frequency range in which the set of multiple synchronization signal blocks may be transmitted.

Some examples of the method, apparatuses, and non-transitory computer-readable medium described herein may further include operations, features, means, or instructions for transmitting, to the UE, control signaling instructing the UE to determine the one or more virtual transmission beams.

### BRIEF DESCRIPTION OF THE DRAWINGS

FIG. 1 illustrates an example of a wireless communications system that supports synthesized synchronization signal block (SSB) beams in accordance with examples as disclosed herein.

FIG. 2 illustrates an example of a system that supports synthesized SSB beams in accordance with examples as disclosed herein.

FIG. 3 illustrates an example of a virtual beam derivation scheme that supports synthesized SSB beams in accordance with examples as disclosed herein.

FIG. 4 illustrates an example of a process flow that supports synthesized SSB beams in accordance with examples as disclosed herein.

FIGS. 5 and 6 show block diagrams of devices that support synthesized SSB beams in accordance with examples as disclosed herein.

FIG. 7 shows a block diagram of a communications manager that supports synthesized SSB beams in accordance with examples as disclosed herein.

FIG. 8 shows a diagram of a system including a device that supports synthesized SSB beams in accordance with examples as disclosed herein.

FIGS. 9 and 10 show block diagrams of devices that support synthesized SSB beams in accordance with examples as disclosed herein.

FIG. 11 shows a block diagram of a communications manager that supports synthesized SSB beams in accordance with examples as disclosed herein.

FIG. 12 shows a diagram of a system including a device that supports synthesized SSB beams in accordance with examples as disclosed herein.

FIGS. 13 through 17 show flowcharts illustrating methods that support synthesized SSB beams in accordance with examples as disclosed herein.

### DETAILED DESCRIPTION

In the course of wireless communications, a user equipment (UE) may communicate with a base station, and the base station may transmit one or more synchronization signal blocks (SSBs) to the UE (e.g., for initial cell searching, acquisition of downlink synchronization, transmission of system information, or other procedures). The base station may transmit the SSBs using different beams (e.g., using different time and frequency resources). The UE may measure the different received SSBs, and from the measurements, report to the base station a preferred or suggested beam for future communications with the base station. However, communications performance and physical security may suffer due to the limited amount of beams used to transmit the SSBs to the UE.

To improve communications performance and security, the UE may determine that the preferred or suggested beam for future communications with the base station is a beam other than those used by the base station to transmit SSB. To determine the preferred or suggested beam, the UE may determine one or more virtual beams which are based on combinations of one or more received SSB beams or indices. The UE may select one or more candidate beams from both the originally received beams and the newly synthesized beams, and may transmit an indication of the candidate beams to the base station, which may select one or more of the candidate beams for use in communications with the UE. In this way, additional options for beams may be provided to the UE, resulting in improved beam quality for communications between the base station and the UE. Further, by synthesizing additional beams or indices, the UE and the base station are provided with additional options for physical layer security (e.g., generation of secret keys).

Aspects of the disclosure are initially described in the context of wireless communications systems. Aspects of the disclosure are further described in the context of a system, a virtual beam derivation scheme, and a process flow. Aspects of the disclosure are further illustrated by and described with reference to apparatus diagrams, system diagrams, and flowcharts that relate to synthesized SSB beams.

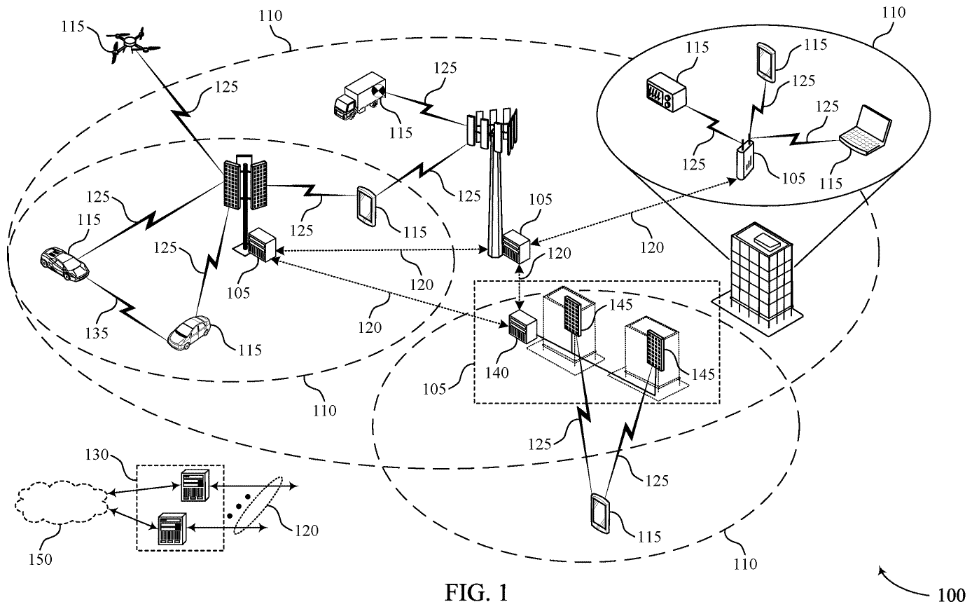

FIG. 1 illustrates an example of a wireless communications system 100 that supports synthesized SSB beams in accordance with examples as disclosed herein. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

A user equipment (UE) may receive (e.g., from a base station), a plurality of SSBs over a plurality of transmission beams. The SSBs may be used to aid the UE in initial cell searching procedures, for example. However, potential communications over the transmission beams over which the SSBs are transmitted may be improved. For example, the transmission beams may not be refined enough to offer improved communications quality. The UE may determine one or more virtual transmission beams based on combinations of one or more of the plurality of transmission beams. For example, if a base station transmitted two SSBs over two transmission beams, the UE may use the two transmission beams (e.g., by using the beam indices) to derive one or more virtual beams (e.g., by combining the beam indices) that may offer more refined beams. Such approaches may offer better beamforming, better communications quality, other advantages, or any combination thereof. In this way, the UE has a larger “pool” of possible beams to select from. From this pool, the UE may select one or more candidate transmission beams for communications between the base station and the UE. For example, the “pool” may include the transmission beams over which the base station transmitted the SSBs, for example, the one or more virtual transmission beams derived by the UE, or any combination thereof. Once the possible candidate beams are selected, the UE may transmit, to the base station, an indication of these one or more candidate transmission beams for further operations (e.g., the base station may select one or more of the candidate beams to use for further communications operations).

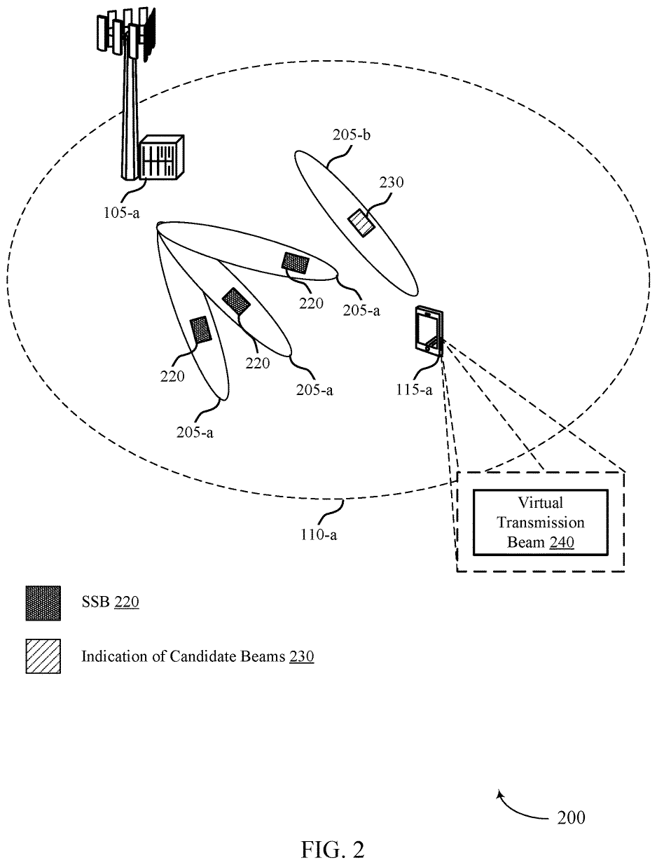

FIG. 2 illustrates an example of a system 200 that supports synthesized SSB beams in accordance with examples as disclosed herein. The system 200 may include a base station 105-a that may be an example of the base station 105 discussed in relation to FIG. 1. The system 200 may include UE 115-a that may be an example of UE 115 discussed in relation to FIG. 1. In some examples, the base station 105-a and the UE 115 a may be located in a geographic coverage area 110-a. The base station 105-a and UE 115-a may communicate via a downlink transmission beam 205-a (or multiple downlink transmission beams 205-a) and an uplink transmission beam 205-b (or multiple uplink transmission beams 205-b).

The base station 105-a may transmit an SSB 220 over a downlink transmission beam 205-a or may transmit multiple SSBs 220 over multiple downlink transmission beams 205-a. The base station 105-a may transmit such SSBs 220 to aid the UE 115-a in initial cell searching or for other wireless communications procedures. Such an SSB 220 may span a length of time (e.g., one or more symbols, such as OFDM symbols). For example, an SSB 220 may span four OFDM symbols, and may allocate one or more symbols to one or more different elements of the SSB (e.g., including a primary synchronization signal (PSS), a physical broadcast channel (PBCH), a secondary synchronization signal (SSS), other elements, or any combination thereof). For example, an SSB may allocate one symbol to a PSS, two symbols to the PBCH, and one symbol to the SSS. In some examples, the SSS and the PBCH may be multiplexed (e.g., through FDM or other multiplexing approaches). In some examples, one or more SCS options may be employed, and such options may be associated with different frequency ranges. For example, a first frequency range may be associated with an SCS of 15 kHz or 30 kHz, and a second frequency range may be associated with an SCS of 120 kHz or 240 kHz.

In some examples, the PSS may employ a frequency domain-based sequence (e.g., an M-sequence of a length of 127) that may be of a mapped to a number of subcarriers (e.g., 127 subcarriers). Such an arrangement may be capable of employing multiple different sequences (e.g., three sequences). In some examples, the SUB-SLOTS may employ a frequency domain-based Gold Code sequence (e.g., 2 M-sequences) that may be of a defined length (e.g., 127) that may be mapped to a number of subcarriers (e.g., 127 subcarriers). Such an arrangement may be capable of many sequences (e.g., up to 1008 possible sequences). In some examples, the PBCH may be modulated (e.g., though QPSK). In some examples, the PBCH may be coherently demodulated using an associated demodulation reference signal (DMRS).

In some examples, the UE 115-a may acquire synchronization (e.g., downlink synchronization), system information, or both, based upon the SSBs 220. The base station 105-a may transmit the SSBs 220 over one or more downlink transmission beams 205-a (e.g., using a TDM approach). Additionally or alternatively, the base station 105-a may transmit the SSBs 220 over different frequency resources (e.g., via the use of synchronization rasters). In some examples, a UE 115-a may receive signaling associated with a subset of beams transmitted by the base station 105-a. For example, the UE 115-a may recognize a single SSB 220 transmitted over a single downlink transmission beam 205-a. As such, the UE 115-a may not recognize or be aware of one or more other SSBs 220 transmitted by the base station 105-a. Therefore, communications quality may suffer as a result.

To reduce or eliminate such impacts on communications quality, the UE 115-a may derive a virtual transmission beam 240 (or multiple virtual transmission beams 240). The UE 115-a may derive such virtual transmission beams 240 based on one or more downlink transmission beams 205-a (e.g., that were used to transmit the SSBs 220 to the UE 115-a). The UE 115-a may use all of the downlink transmission beams 205-a of which the UE 115-a is “aware” or recognizes, or may use a subset thereof for the derivation of the virtual transmission beam 240. Once the UE 115-a derives one or more virtual transmission beams 240, the UE 115-a may determine or select one or more candidate transmission beams for use in further communications (e.g., with the base station 105-a). The UE 115-a may select the one or more candidate transmission beams from the downlink transmission beams 205-a, the one or more derived virtual transmission beams 240, or both. Various combinations of beams selected as candidate beams are possible and contemplated by the subject matter disclosed herein. The UE 115-a may transmit (e.g., to the base station 105-a or other device) an indication (e.g., the indication of candidate beams 230) of the one or more beams that the UE 115-a has selected as candidate beams.

As described herein, the base station 105-a may transmit a quantity of SSBs 220 using a number of downlink transmission beams 205-a. The UE 115-a may then measure a signal strength or quality of each of the downlink transmission beams 205-a. For example, the UE 115-a may receive a first downlink transmission beams 205-a (e.g., h₁), a second downlink transmission beam 205-a (e.g., h₂), and so on for downlink transmission beams 205-a through h_{L} for quantity of transmission beams L. Further, the base station 105-a may configure a quantity of PMIs (e.g., k PMIs), and the base station 105-a may transmit the quantity of PMIs to the UE 115-a. The UE 115-a may apply one or more codebooks to the received PMIs across the received channels of the quantity of SSBs 220. Further, the UE 115-a may derive one or more channels, beams, indices, or any combination thereof that correspond to one or more combinations of the received SSBs 220, the downlink transmission beams 205-a, or any combination thereof.

Equations 1-4 below demonstrate some examples of such a process. By evaluating different combinations of received downlink transmission beams 205-a (e.g., their associated channels represented by h₁, h₂, h₃, h₄ in this example), the UE 115-a may derive one or more virtual transmission beams 240 (e.g., a beam represented by the combination of channels h₁+h₂+h₃+h₄, a beam represented by the combination of channels h₁+h₂+h₃, a beam represented by the combination of channels h₁+h₃+h₄, and a beam represented by the combination of channels h₁+h₂+h₄). The UE 115-a may measure a reference signal received power (RSRP) or other measurement for one or more of the actual indices or beams, one or more of the virtual transmission beams 240 (e.g., that are derived using a configured codebook), or any combination thereof. The UE 115-a may rank the various beams (e.g., one or more actual beams, one or more derived beams, or any combination thereof) and may transmit an indication of such beams to the base station 105-a. Additionally or alternatively, the UE 115-a may select a subset of such beams, and transmit an indication of the subset. Additionally or alternatively, the UE 115-a may transmit an indication of a suggestion of one or more subsets of the beams to be combined to form one or more actual beams corresponding to one or more virtual beams derived by the UE 115-a.

$$[ {h}_{1} , {h}_{2} , {h}_{3} , {h}_{4} ] * [ \begin{matrix}1 \\ 1 \\ 1 \\ 1\end{matrix} ] = {h}_{1} + {h}_{2} + {h}_{3} + {h}_{4} \qquad ( 1 )$$

$$[ {h}_{1} , {h}_{2} , {h}_{3} , {h}_{4} ] * [ \begin{matrix}1 \\ 1 \\ 1 \\ 0\end{matrix} ] = {h}_{1} + {h}_{2} + {h}_{3} \qquad ( 2 )$$

$$[ {h}_{1} , {h}_{2} , {h}_{3} , {h}_{4} ] * [ \begin{matrix}1 \\ 0 \\ 1 \\ 1\end{matrix} ] = {h}_{1} + {h}_{3} + {h}_{4} \qquad ( 3 )$$

$$[ {h}_{1} , {h}_{2} , {h}_{3} , {h}_{4} ] * [ \begin{matrix}1 \\ 1 \\ 0 \\ 1\end{matrix} ] = {h}_{1} + {h}_{2} + {h}_{4} \qquad ( 4 )$$

In another example of such a virtual beam derivation process, the base station 105-a may configure one or more downlink transmission beams 205-a, one or more associated ports, one or more associated indices, or any combination thereof, based on one or more frequency ranges in which communications are to take place. The base station 105-a may configure a PMI codebook or may configure the UE 115-a to compute the PMI codebook and transmit it to the base station 105-a. In either case, the PMI codebook may be associated with the downlink transmission beams 205-a, associated indices, or both, and the UE 115-a may apply such a PMI codebook to one or more measured beams (e.g., the downlink transmission beams 205-a) bearing the SSBs 220 to derive one or more virtual beams. In some examples, for each PMI in the codebook, a virtual beam may be derived (e.g., using a corresponding PMI, a quantity of measured beams, such as the downlink transmission beams 205-a, or any combination thereof). Such a virtual beam may be referred to as a virtual beam (e.g., the virtual transmission beam 240), a synthesized beam, or a derived beam. Such an approach may allow the UE 115-a to derive a virtual beam that may be based on multiple channels of actual received beams (e.g., the downlink transmission beams 205-a) without the base station 105-a transmitting an SSB 220 over another actual beam formed at the base station 105-a (e.g., through the use of filters or analog beamforming).

In some examples, the base station 105-a, the UE 115-a, or both, may update one or more PMI values, one or more weights, a combiner, or any combination thereof as needed. In some examples (e.g., for additional flexibility or security), the base station 105-a may switch between PMIs recommended by the UE 115-a, since the UE 115-a may transmit an indication of multiple beams as preferred or suggested beams to use for transmission. Such an approach may provide additional security based on more factors being present in a security scheme.

In some examples, one or more actual transmission beams (e.g., downlink transmission beams 205-a) one or more virtual transmission beams 240, or any combination thereof may be associated with an identifier, and such identifiers may be used to configure quasi-co-location, one or more CSI-RSs, or any combination thereof. In some examples, a table or other record of beam identifiers (e.g., associated with actual beams, virtual beams, or both) may be stored (e.g., at the UE 115-a or the base station 105-b). In some examples, the base station 105-b may modify the table (e.g., by updating one or more values, removing one or more values, adding one or more values, or any combination thereof). In some examples, such a configuration may be carried out using control signaling (e.g., RRC, MAC-CE, DCI, other signaling, or any combination thereof).

In the preceding description, approaches for deriving the virtual transmission beams 240 are described. However, the subject matter described throughout is not limited to deriving virtual transmission beams 240. For example, virtual reference signals, ports, beams, or any combination thereof may also be derived (e.g., CSI-RSs, tracking reference signals (TRSs), or any combination thereof). For example, a UE (e.g., UE 115-a) may receive one or more reference signals associated with one or more reference signal ports. The UE may derive one or more virtual reference signal ports based on any combination of the one or more reference signals associated with the one or more reference signal ports. The UE may then have a larger “pool” of potential reference signal ports (e.g., including the reference signal ports associated with the received reference signals, the one or more derived or virtual reference signal ports, or any combination thereof) to select from for further wireless communications processes or procedures. The UE may select one or more candidate reference signal ports for further wireless communications processes or procedures. The UE may further transmit an indication of the one or more candidate reference signal ports to a base station (e.g., base station 105-a). In this way, communications quality or effectiveness may be increased.

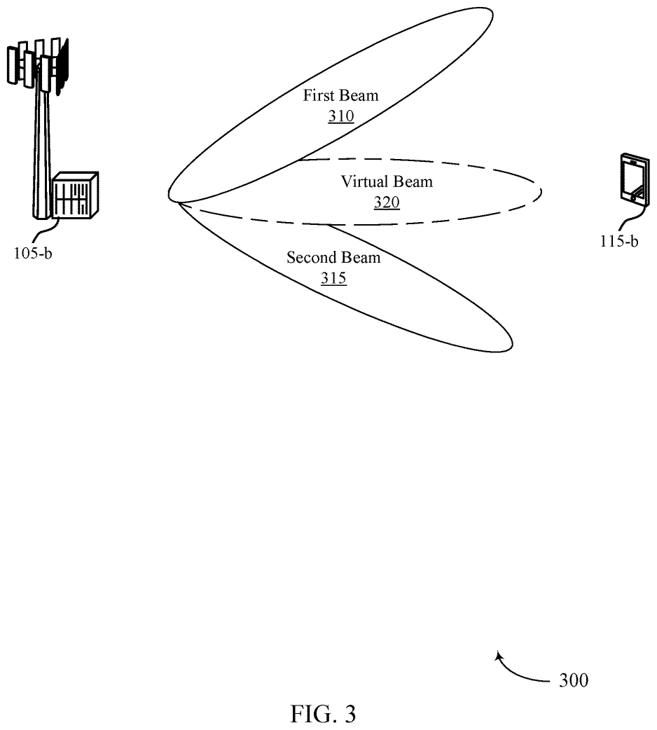

FIG. 3 illustrates an example of a virtual beam derivation scheme 300 that supports synthesized SSB beams in accordance with examples as disclosed herein. The virtual beam derivation scheme 300 may include the base station 105-b that may be an example of the base station 105 discussed in relation to FIGS. 1-2. The virtual beam derivation scheme 300 may include UE 115-b that may be an example of UE 115 discussed in relation to FIGS. 1-2.

As described herein, the base station 105-b may transmit one or more SSBs over one or more beams, such as the first beam 310 and the second beam 315. In some examples, the base station 105-b may transmit a defined number of beams, and the defined number of beams may depend on a frequency range. The UE 115-b may receive the SSBs over the one or more beams, such as the first beam 310 and the second beam 315, and the UE 115-b may engage in derivation of one or more virtual beams, such as virtual beam 320. While the virtual beam derivation scheme 300 discusses an example with the first beam 310 and the second beam 315 from which the virtual beam 320 is derived, other combinations or derivation schemes (e.g., schemes involving different numbers of beams transmitted by the base station 105-b or different numbers of virtual beams derived by the UE 115-b) are possible and are contemplated by the subject matter described herein.

In some examples, the first beam 310 and the second beam 315 may each be associated with a beam index. The UE 115-b may use these beam indices to derive the virtual beam 320. For example, the UE 115-b may combine the beam indices of the first beam 310 and the second beam 315. In one example of such combination, the first beam 310 may be associated with a beam index “0,” and the second beam 315 may be associated with a beam index “1.” The UE 115-b may combine these indices to derive a new beam index, “0_1,” that may be associated with the virtual beam 320. The virtual beam 320 may be better for serving the UE 115-b, since the virtual beam 320 may be derived based on one or more communications metrics (e.g., channel quality metrics), and the UE 115-b may derive the virtual beam 320 to have one or more characteristics that are improved as compared to the first beam 310 or the virtual beam 320.

In a more general sense, the UE 115-b may combine a first beam index “x” with a second beam index “y” to derive a new beam index “x_y.” Such newly-derived beam indices (e.g., that are associated with a virtual beam, such as virtual beam 320) may be referred to as virtual indices, synthesized indices, or derived indices, and related beams may be referred to as virtual beams (e.g., the virtual beam 320), synthesized beams, or derived beams.

By increasing the number of beams, indices, or both that are available for use through derivation of virtual beams, a system may include additional or improved capabilities without the burden of additional signaling to include such beams, indices, or both. For example, a system may employ more refined beams for serving a UE (e.g., UE 115-b). The UE 115-b may derive the virtual beam 320, and the base station 105-b may create a new beam for use in communicating with the UE 115-b. The derived virtual beam 320 and the actual beam created by the base station 105-b may be based on combined indices across different beamformers. Additionally or alternatively, combining beams (e.g., the first beam 310 and the virtual beam 320) may achieve better beamforming performance, since combined beams may approximate a singular value decomposition (SVD) beamformer. Additionally or alternatively, the combination of indices (or another indication of the virtual beam 320) may be transmitted by the UE 115-b to the base station 105-b, and the base station 105-b may configure the UE 115-b with one or more PMI values, and the UE 115-b may use one or more of the transmitted PMI values in the course of communication. Additionally or alternatively, the UE 115-b may be configured to compute a combination of indices or beams (including actual beams, virtual beams, or both) and may signal such a combination to the base station 105-b. In some examples, increasing the number of beams, indices, or both may allow for better beams to serve the UE 115-b through the use of associations or quasi-co-location between CSI-RS, DMRS, a tracking reference signal (TRS), or any combination thereof.

In some examples, the UE 115-b may employ one or more criteria (e.g., an L1-L3 RSRP, an L1/L3 signal to noise and interference ratio (SINR), or any combination thereof) to rank one or more actual beams (e.g., first beam 310 and second beam 315), one or more virtual beams (e.g., virtual beam 320), or any combination thereof. The UE 115-b may report all or a subset of such beams to the network (e.g., to the base station 105-b), optionally based on the criteria discussed herein. For example, if a situation involves L actual beams, and Y derived beams, the UE 115-b may rank the L+Y beams and report all or a subset of such beams. Beams 1, 2, 3, L may correspond to actual measured beams (e.g., first beam 310 and second beam 315), and beams L+1, L+2, L+Y may correspond to derived virtual beams (e.g., virtual beam 320). In some examples, the UE 115-b may determine or derive RSRP, SINR, or both, for one or more actual beams, one or more derived virtual beams, or any combination thereof. The UE 115-b may make such a determination or derivation according to the received PMI codebook, as discussed herein.

The use of such approaches may enable the base station 105-b to determine a subset of beams that would offer increased performance for communications with the UE 115-b (e.g., for transmission of one or more CSI-RSs, one or more transmissions over a PDSCH, one or more other transmissions, or any combination thereof), and may further allow the base station 105-b to determine or select one or more combiners or PMIs to be used in association with communications with the UE 115-b.

Additionally or alternatively, the use of additional beams, indices, or both may also provide increased security of transmissions. For example, physical layer security may be increased (e.g., when physical layer parameters may be used to generate one or more secret keys for security purposes). By providing additional beams, indices, or both, the options provided regarding such beams, indices, or both are increased, thereby confusing potential attackers. For example, the UE 115-b may use a key derivation function (KDF) where the secret key is KDF (e.g., including upper-layer inputs, key refresh, one or more beam indices related to a transmission configuration indicator (TCI) state or the corresponding combiner, PMI, or both of the synthesized SSB beam, or any combination thereof). For example, a beam index parameter may have many options (e.g., multiple times as compared to a scenario without derived beams, indices, or both), so eavesdroppers (e.g., passive attackers) cannot just try the original number of SSB beams (which, in some cases, may be a low number) to extract the secret key. In some examples, the TCI state, which may point to an SSB beam (e.g., that may be a synthesized or virtual beam), may be RRC configured, which may be L3 secured. Hence, by relying on a beam index, value, PMI, combiner, or any combination thereof, a secret key can be agreed upon with a high probability of being secured, since an attacker will have to try many numbers of combinations to determine a state, a synthesized SSB beam, its index, or any combination thereof.

Additionally or alternatively, the base station 105-b may transmit a PMI value or combiner to the UE 115-b so that the UE 115-b may use such information in associated with a secret key exchange. For example, the base station 105-b may select from one or more PMIs that the UE 115-b may recommend. Additionally or alternatively, the base station 105-b may select or determine a different combiner or beam index from which the base station 105-b may select one or more PMIs.

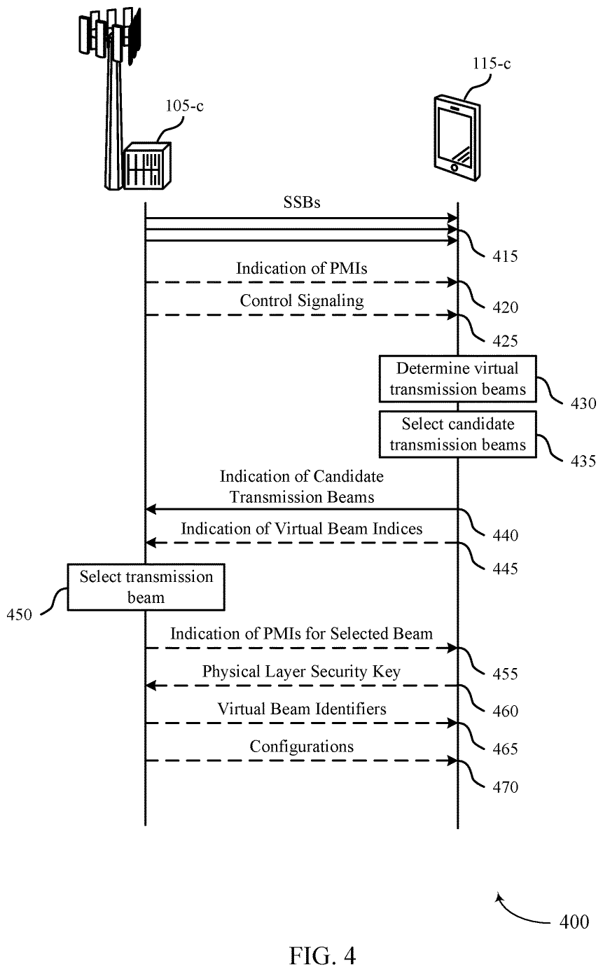

FIG. 4 illustrates an example of a process flow 400 that supports synthesized SSB beams in accordance with examples as disclosed herein. The process flow 400 may implement various aspects of the present disclosure described with reference to FIGS. 1-3. The process flow 400 may include a UE 115-c and a base station 105-c, which may be examples of UE 115 and base station 105 as described with reference to FIGS. 1-3. In the following description of the process flow 400, the operations between the UE 115-c and the base station 105-c may be performed in different orders or at different times. Some operations may also be left out of the process flow 400, or other operations may be added. Although the UE 115-c and the base station 105-c are shown performing the operations of the process flow 400, some aspects of some operations may also be performed by the base station 105-c, the UE 115-c, one or more other wireless devices, or any combination thereof.

At 415, the UE 115-c may receive, from the base station 105-c, a plurality of synchronization signal blocks over a plurality of transmission beams. In some examples, the plurality of synchronization signal blocks are configured based at least in part on a frequency range in which the plurality of synchronization signal blocks are transmitted.

At 420, the UE 115-c may receive, from the base station 105-c, an indication of a plurality of precoding matrix indicators associated with the plurality of transmission beams.

At 425, the UE 115-c may receive, from the base station 105-c, control signaling instructing the UE to determine the one or more virtual transmission beams.

At 430, the UE 115-c may determine one or more virtual transmission beams based at least in part on corresponding combinations of individual ones of the plurality of transmission beams. In some examples, the UE 115-c may determine the one or more virtual transmission beams based at least in part on the plurality of precoding matrix indicators.

At 435, the UE 115-c may select one or more candidate transmission beams for communications between the base station and the UE, the one or more candidate transmission beams being selected from the plurality of transmission beams and the one or more virtual transmission beams. In some examples, the UE 115-c may determine one or more channel quality metrics associated with the plurality of transmission beams and the one or more virtual transmission beams, and selecting the one or more candidate transmission beams may be based at least in part on the one or more channel quality metrics. In some examples, the UE 115-c may rank the one or more candidate transmission beams based at least in part on the one or more channel quality metrics.

At 440, the UE 115-c may transmit, to the base station 105-c, an indication of the one or more candidate transmission beams. In some examples, the UE 115-c may transmit the indication of the one or more candidate transmission beams based at least in part on the ranking.

At 445, the UE 115-c may transmit, to the base station 105-c, an indication of one or more virtual transmission beam indices corresponding to the one or more virtual transmission beams based at least in part on one or more indices of the individual ones of the plurality of transmission beams.

At 450, the base station 105-c may select the transmission beam from the one or more candidate transmission beams.

At 455, the UE 115-c may receive, from the base station 105-c, an indication of one or more precoding matrix indicator values associated with a transmission beam selected from the one or more candidate transmission beams. In some examples, the UE 115-c may receive an updated indication of the one or more precoding matrix indicator values.

At 460, the UE 115-c may transmit, to the base station 105-c, an indication of a physical layer security key generated based at least in part on the indication of the one or more precoding matrix indicator values.

At 465, the UE 115-c may receive, from the base station 105-c, an indication of one or more identifiers associated with the one or more virtual transmission beams.

At 470, the UE 115-c may receive, from the base station 105-c, one or more configurations based at least in part on the one or more identifiers.

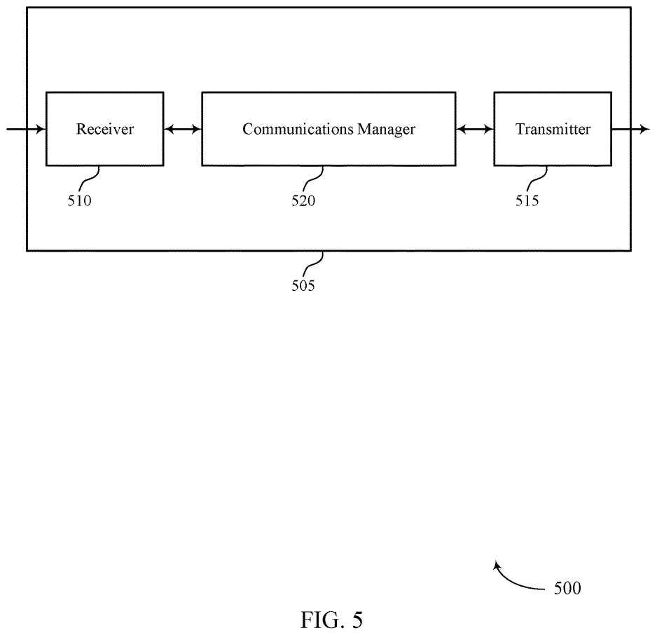

FIG. 5 shows a block diagram 500 of a device 505 that supports synthesized SSB beams in accordance with examples as disclosed herein. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to synthesized SSB beams). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to synthesized SSB beams). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of synthesized SSB beams as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a UE in accordance with examples as disclosed herein. For example, the communications manager 520 may be configured as or otherwise support a means for receiving, from a base station, a set of multiple synchronization signal blocks over a set of multiple transmission beams. The communications manager 520 may be configured as or otherwise support a means for determining one or more virtual transmission beams based on corresponding combinations of individual ones of the set of multiple transmission beams. The communications manager 520 may be configured as or otherwise support a means for selecting one or more candidate transmission beams for communications between the base station and the UE, the one or more candidate transmission beams being selected from the set of multiple transmission beams and the one or more virtual transmission beams. The communications manager 520 may be configured as or otherwise support a means for transmitting, to the base station, an indication of the one or more candidate transmission beams.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for reduced processing, reduced power consumption, more efficient utilization of communication resources, or a combination thereof.

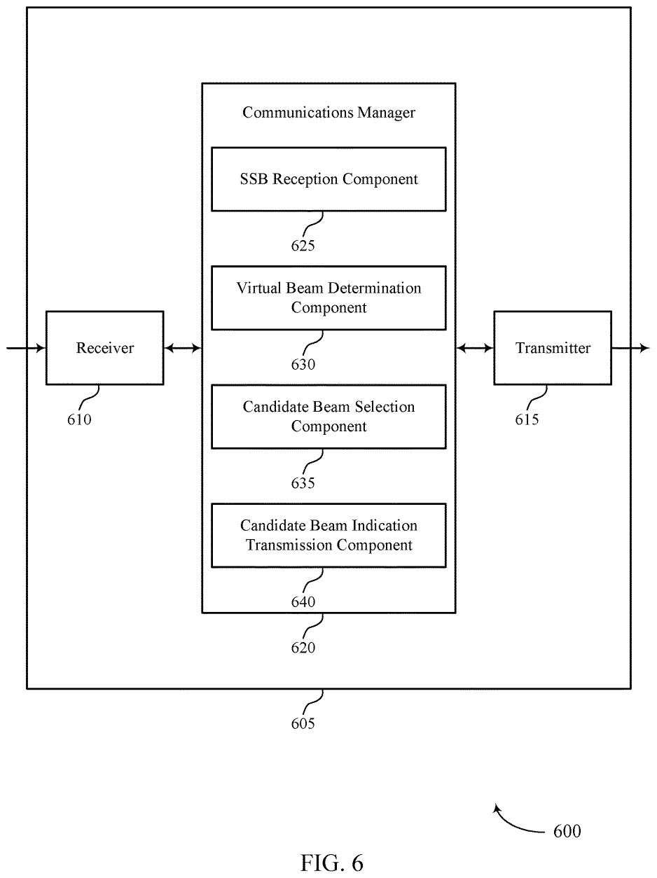

FIG. 6 shows a block diagram 600 of a device 605 that supports synthesized SSB beams in accordance with examples as disclosed herein. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to synthesized SSB beams). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to synthesized SSB beams). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of synthesized SSB beams as described herein. For example, the communications manager 620 may include an SSB reception component 625, a virtual beam determination component 630, a candidate beam selection component 635, a candidate beam indication transmission component 640, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a UE in accordance with examples as disclosed herein. The SSB reception component 625 may be configured as or otherwise support a means for receiving, from a base station, a set of multiple synchronization signal blocks over a set of multiple transmission beams. The virtual beam determination component 630 may be configured as or otherwise support a means for determining one or more virtual transmission beams based on corresponding combinations of individual ones of the set of multiple transmission beams. The candidate beam selection component 635 may be configured as or otherwise support a means for selecting one or more candidate transmission beams for communications between the base station and the UE, the one or more candidate transmission beams being selected from the set of multiple transmission beams and the one or more virtual transmission beams. The candidate beam indication transmission component 640 may be configured as or otherwise support a means for transmitting, to the base station, an indication of the one or more candidate transmission beams.

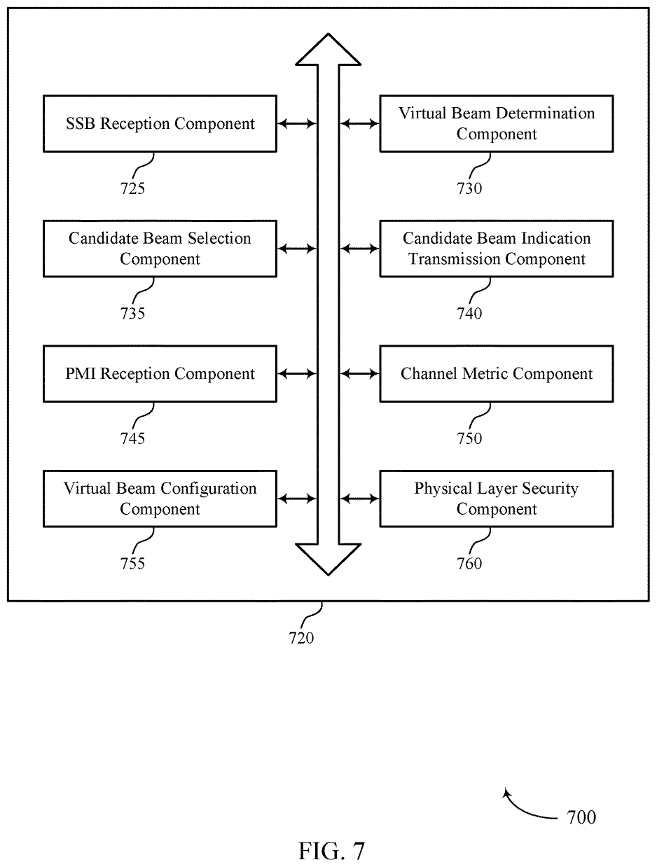

FIG. 7 shows a block diagram 700 of a communications manager 720 that supports synthesized SSB beams in accordance with examples as disclosed herein. The communications manager 720 may be an example of aspects of a communications manager 520, a communications manager 620, or both, as described herein. The communications manager 720, or various components thereof, may be an example of means for performing various aspects of synthesized SSB beams as described herein. For example, the communications manager 720 may include an SSB reception component 725, a virtual beam determination component 730, a candidate beam selection component 735, a candidate beam indication transmission component 740, a PMI reception component 745, a channel metric component 750, a virtual beam configuration component 755, a physical layer security component 760, or any combination thereof. Each of these components may communicate, directly or indirectly, with one another (e.g., via one or more buses).

The communications manager 720 may support wireless communication at a UE in accordance with examples as disclosed herein. The SSB reception component 725 may be configured as or otherwise support a means for receiving, from a base station, a set of multiple synchronization signal blocks over a set of multiple transmission beams. The virtual beam determination component 730 may be configured as or otherwise support a means for determining one or more virtual transmission beams based on corresponding combinations of individual ones of the set of multiple transmission beams. The candidate beam selection component 735 may be configured as or otherwise support a means for selecting one or more candidate transmission beams for communications between the base station and the UE, the one or more candidate transmission beams being selected from the set of multiple transmission beams and the one or more virtual transmission beams. The candidate beam indication transmission component 740 may be configured as or otherwise support a means for transmitting, to the base station, an indication of the one or more candidate transmission beams.

In some examples, the candidate beam indication transmission component 740 may be configured as or otherwise support a means for transmitting, to the base station, an indication of one or more virtual transmission beam indices corresponding to the one or more virtual transmission beams based on one or more indices of the individual ones of the set of multiple transmission beams.

In some examples, the PMI reception component 745 may be configured as or otherwise support a means for receiving, from the base station, an indication of a set of multiple precoding matrix indicators associated with the set of multiple transmission beams. In some examples, the virtual beam determination component 730 may be configured as or otherwise support a means for determining the one or more virtual transmission beams based on the set of multiple precoding matrix indicators.

In some examples, the channel metric component 750 may be configured as or otherwise support a means for determining one or more channel quality metrics associated with the set of multiple transmission beams and the one or more virtual transmission beams, where selecting the one or more candidate transmission beams is based on the one or more channel quality metrics. In some examples, the candidate beam selection component 735 may be configured as or otherwise support a means for ranking the one or more candidate transmission beams based on the one or more channel quality metrics. In some examples, the candidate beam indication transmission component 740 may be configured as or otherwise support a means for transmitting the indication of the one or more candidate transmission beams based at least in part on the ranking.

In some examples, the PMI reception component 745 may be configured as or otherwise support a means for receiving, from the base station, an indication of one or more precoding matrix indicator values associated with a transmission beam selected from the one or more candidate transmission beams.

In some examples, the physical layer security component 760 may be configured as or otherwise support a means for transmitting, to the base station, an indication of a physical layer security key generated based on the indication of the one or more precoding matrix indicator values.

In some examples, the PMI reception component 745 may be configured as or otherwise support a means for receiving an updated indication of the one or more precoding matrix indicator values.

In some examples, the virtual beam configuration component 755 may be configured as or otherwise support a means for receiving, from the base station, an indication of one or more identifiers associated with the one or more virtual transmission beams. In some examples, the virtual beam configuration component 755 may be configured as or otherwise support a means for receiving, from the base station, one or more configurations based on the one or more identifiers.

In some examples, the set of multiple synchronization signal blocks are configured based on a frequency range in which the set of multiple synchronization signal blocks are transmitted.

In some examples, the virtual beam configuration component 755 may be configured as or otherwise support a means for receiving, from the base station, control signaling instructing the UE to determine the one or more virtual transmission beams.

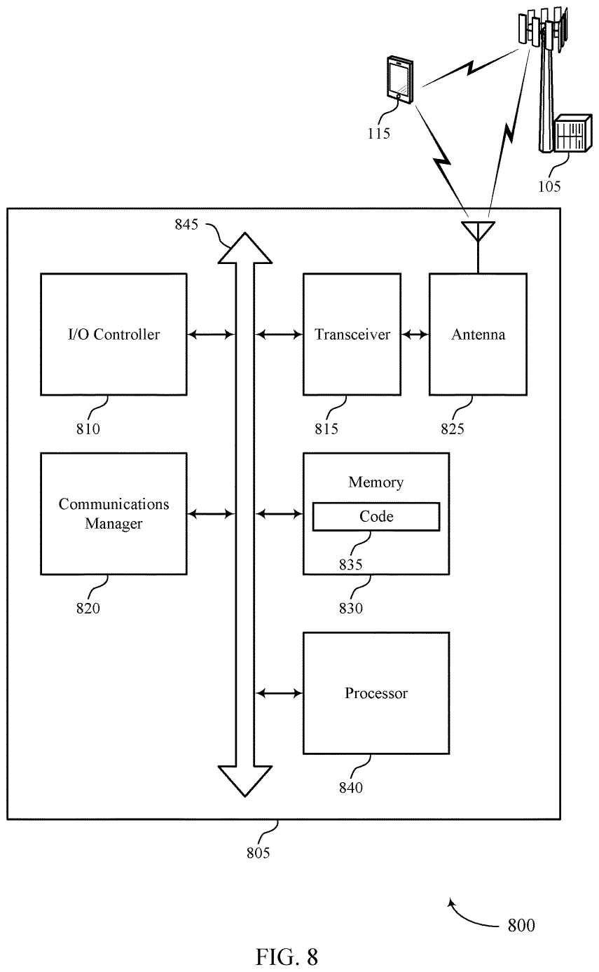

FIG. 8 shows a diagram of a system 800 including a device 805 that supports synthesized SSB beams in accordance with examples as disclosed herein. The device 805 may be an example of or include the components of a device 505, a device 605, or a UE 115 as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting synthesized SSB beams). For example, the device 805 or a component of the device 805 may include a processor 840 and memory 830 coupled with the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for receiving, from a base station, a set of multiple synchronization signal blocks over a set of multiple transmission beams. The communications manager 820 may be configured as or otherwise support a means for determining one or more virtual transmission beams based on corresponding combinations of individual ones of the set of multiple transmission beams. The communications manager 820 may be configured as or otherwise support a means for selecting one or more candidate transmission beams for communications between the base station and the UE, the one or more candidate transmission beams being selected from the set of multiple transmission beams and the one or more virtual transmission beams. The communications manager 820 may be configured as or otherwise support a means for transmitting, to the base station, an indication of the one or more candidate transmission beams.

By including or configuring the communications manager 820 in accordance with examples as described herein, the device 805 may support techniques for improved communication reliability, reduced latency, improved user experience related to reduced processing, reduced power consumption, more efficient utilization of communication resources, improved coordination between devices, longer battery life, improved utilization of processing capability, or a combination thereof.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of synthesized SSB beams as described herein, or the processor 840 and the memory 830 may be otherwise configured to perform or support such operations.

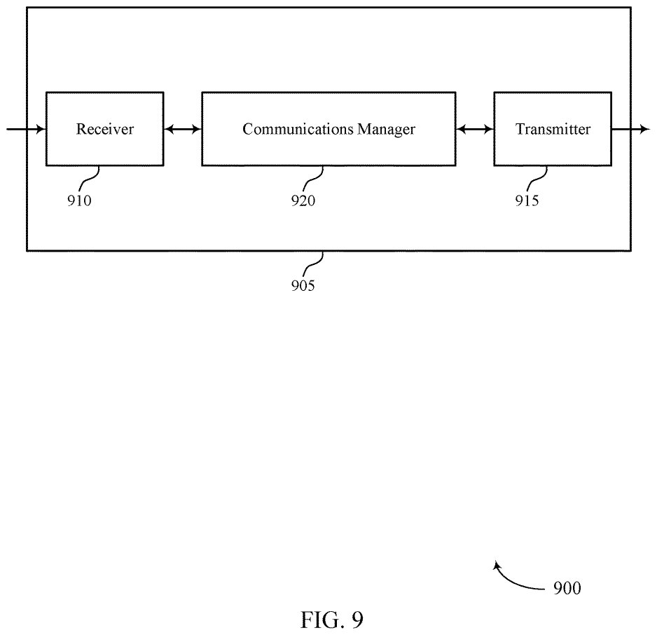

FIG. 9 shows a block diagram 900 of a device 905 that supports synthesized SSB beams in accordance with examples as disclosed herein. The device 905 may be an example of aspects of a base station 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to synthesized SSB beams). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to synthesized SSB beams). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of synthesized SSB beams as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 920 may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at a base station in accordance with examples as disclosed herein. For example, the communications manager 920 may be configured as or otherwise support a means for transmitting, to a UE, a set of multiple synchronization signal blocks over a corresponding set of multiple transmission beams. The communications manager 920 may be configured as or otherwise support a means for receiving, from the UE, an indication of one or more candidate transmission beams for communications between the base station and the UE, where the one or more candidate transmission beams include one or more virtual transmission beams that represent combinations of individual ones of the set of multiple transmission beams. The communications manager 920 may be configured as or otherwise support a means for selecting a transmission beam from the one or more candidate transmission beams. The communications manager 920 may be configured as or otherwise support a means for transmitting downlink data to the UE over the transmission beam.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for reduced processing, reduced power consumption, more efficient utilization of communication resources, or a combination thereof.

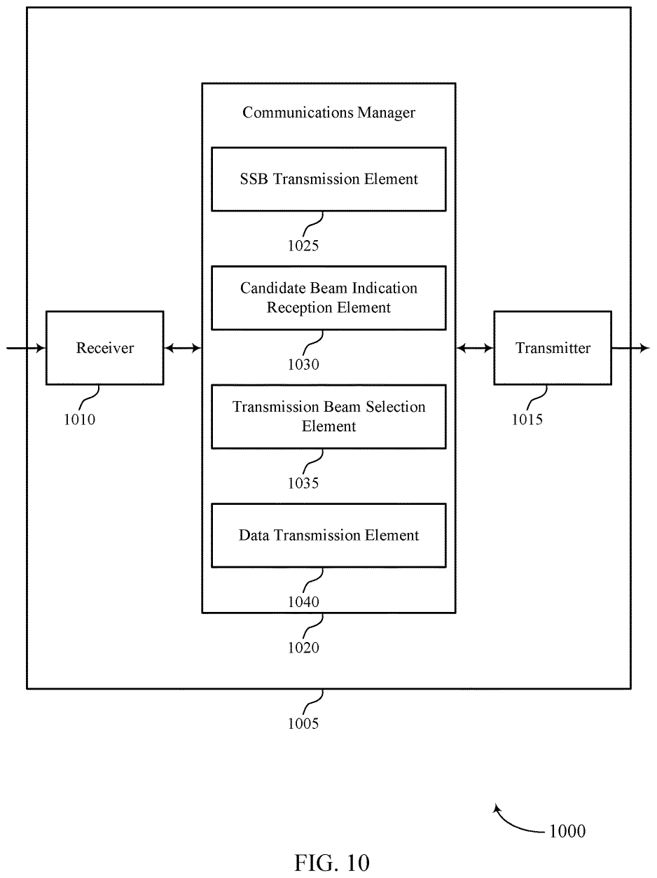

FIG. 10 shows a block diagram 1000 of a device 1005 that supports synthesized SSB beams in accordance with examples as disclosed herein. The device 1005 may be an example of aspects of a device 905 or a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to synthesized SSB beams). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to synthesized SSB beams). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of synthesized SSB beams as described herein. For example, the communications manager 1020 may include an SSB transmission element 1025, a candidate beam indication reception element 1030, a transmission beam selection element 1035, a data transmission element 1040, or any combination thereof. The communications manager 1020 may be an example of aspects of a communications manager 920 as described herein. In some examples, the communications manager 1020, or various components thereof, may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a base station in accordance with examples as disclosed herein. The SSB transmission element 1025 may be configured as or otherwise support a means for transmitting, to a UE, a set of multiple synchronization signal blocks over a corresponding set of multiple transmission beams. The candidate beam indication reception element 1030 may be configured as or otherwise support a means for receiving, from the UE, an indication of one or more candidate transmission beams for communications between the base station and the UE, where the one or more candidate transmission beams include one or more virtual transmission beams that represent combinations of individual ones of the set of multiple transmission beams. The transmission beam selection element 1035 may be configured as or otherwise support a means for selecting a transmission beam from the one or more candidate transmission beams. The data transmission element 1040 may be configured as or otherwise support a means for transmitting downlink data to the UE over the transmission beam.

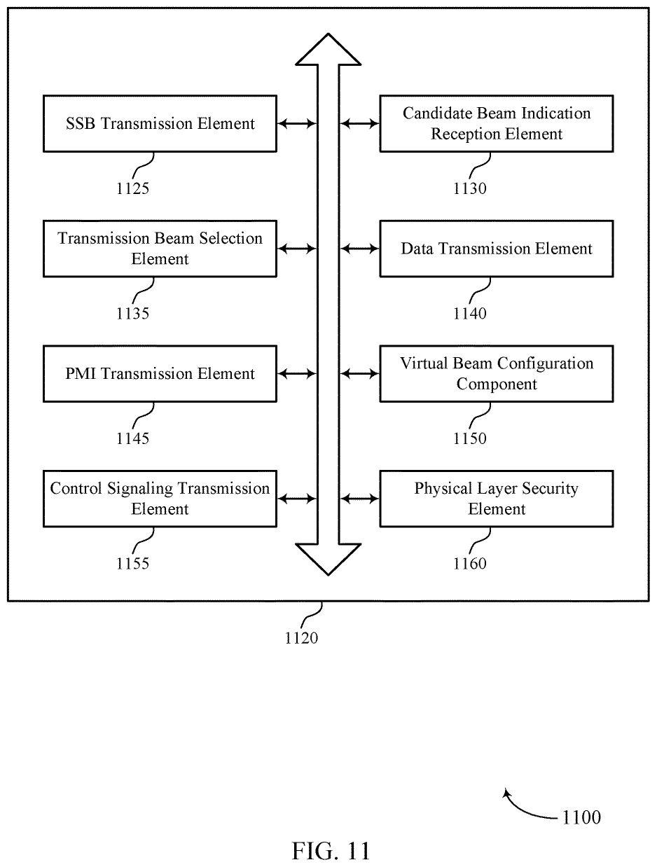

FIG. 11 shows a block diagram 1100 of a communications manager 1120 that supports synthesized SSB beams in accordance with examples as disclosed herein. The communications manager 1120 may be an example of aspects of a communications manager 920, a communications manager 1020, or both, as described herein. The communications manager 1120, or various components thereof, may be an example of means for performing various aspects of synthesized SSB beams as described herein. For example, the communications manager 1120 may include an SSB transmission element 1125, a candidate beam indication reception element 1130, a transmission beam selection element 1135, a data transmission element 1140, a PMI transmission element 1145, a virtual beam configuration component 1150, a control signaling transmission element 1155, a physical layer security element 1160, or any combination thereof. Each of these components may communicate, directly or indirectly, with one another (e.g., via one or more buses).

The communications manager 1120 may support wireless communication at a base station in accordance with examples as disclosed herein. The SSB transmission element 1125 may be configured as or otherwise support a means for transmitting, to a UE, a set of multiple synchronization signal blocks over a corresponding set of multiple transmission beams. The candidate beam indication reception element 1130 may be configured as or otherwise support a means for receiving, from the UE, an indication of one or more candidate transmission beams for communications between the base station and the UE, where the one or more candidate transmission beams include one or more virtual transmission beams that represent combinations of individual ones of the set of multiple transmission beams. The transmission beam selection element 1135 may be configured as or otherwise support a means for selecting a transmission beam from the one or more candidate transmission beams. The data transmission element 1140 may be configured as or otherwise support a means for transmitting downlink data to the UE over the transmission beam.

In some examples, the candidate beam indication reception element 1130 may be configured as or otherwise support a means for receiving, from the UE, an indication of one or more virtual transmission beam indices corresponding to the one or more virtual transmission beams based on one or more indices of the individual ones of the set of multiple transmission beams.

In some examples, the PMI transmission element 1145 may be configured as or otherwise support a means for transmitting, to the UE, an indication of a set of multiple precoding matrix indicators associated with the set of multiple transmission beams.

In some examples, the indication of the one or more candidate transmission beams includes a ranking of the one or more candidate transmission beams.

In some examples, the transmission beam selection element 1135 may be configured as or otherwise support a means for selecting the transmission beam from the one or more candidate transmission beams based on one or more channel quality metrics associated with the one or more candidate transmission beams. In some examples, the PMI transmission element 1145 may be configured as or otherwise support a means for transmitting, to the UE, an indication of one or more precoding matrix indicator values associated with the selected transmission beam.

In some examples, the physical layer security element 1160 may be configured as or otherwise support a means for receiving, from the UE, an indication of a physical layer security key generated based on the indication of the one or more precoding matrix indicator values.

In some examples, the PMI transmission element 1145 may be configured as or otherwise support a means for transmitting, to the UE, an updated indication of the one or more precoding matrix indicator values based on a change in the one or more channel quality metrics.

In some examples, the virtual beam configuration component 1150 may be configured as or otherwise support a means for transmitting, to the UE, an indication of one or more identifiers associated with the one or more virtual transmission beams. In some examples, the virtual beam configuration component 1150 may be configured as or otherwise support a means for transmitting, to the UE, one or more configurations based on the one or more identifiers.

In some examples, the SSB transmission element 1125 may be configured as or otherwise support a means for configuring the set of multiple synchronization signal blocks based on a frequency range in which the set of multiple synchronization signal blocks are transmitted.

In some examples, the control signaling transmission element 1155 may be configured as or otherwise support a means for transmitting, to the UE, control signaling instructing the UE to determine the one or more virtual transmission beams.

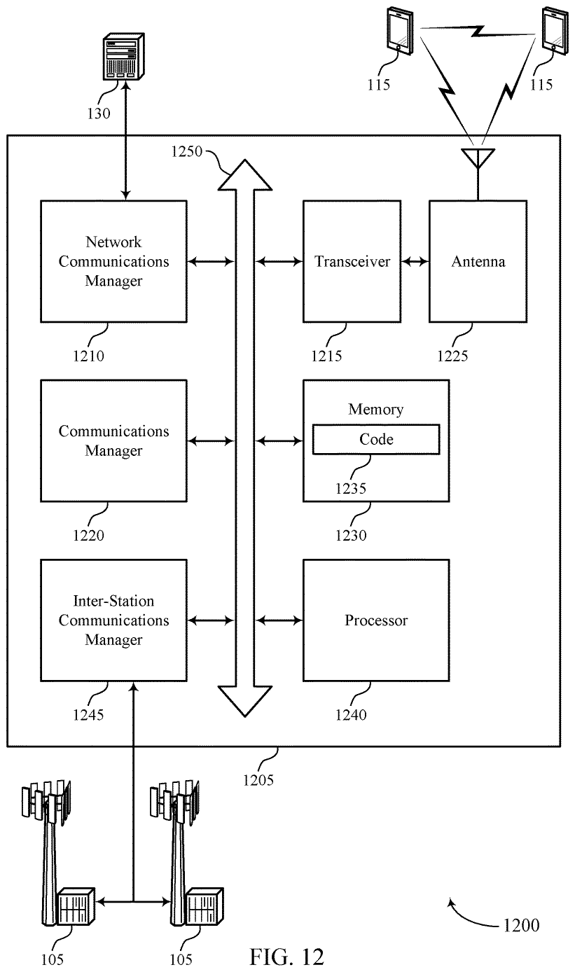

FIG. 12 shows a diagram of a system 1200 including a device 1205 that supports synthesized SSB beams in accordance with examples as disclosed herein. The device 1205 may be an example of or include the components of a device 905, a device 1005, or a base station 105 as described herein. The device 1205 may communicate wirelessly with one or more base stations 105, UEs 115, or any combination thereof. The device 1205 may include components for bi-directional voice and data communications including components for transmitting and receiving communications, such as a communications manager 1220, a network communications manager 1210, a transceiver 1215, an antenna 1225, a memory 1230, code 1235, a processor 1240, and an inter-station communications manager 1245. These components may be in electronic communication or otherwise coupled (e.g., operatively, communicatively, functionally, electronically, electrically) via one or more buses (e.g., a bus 1250).

The network communications manager 1210 may manage communications with a core network 130 (e.g., via one or more wired backhaul links). For example, the network communications manager 1210 may manage the transfer of data communications for client devices, such as one or more UEs 115.

In some cases, the device 1205 may include a single antenna 1225. However, in some other cases the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include RAM and ROM. The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a BIOS which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting synthesized SSB beams). For example, the device 1205 or a component of the device 1205 may include a processor 1240 and memory 1230 coupled with the processor 1240, the processor 1240 and memory 1230 configured to perform various functions described herein.

The inter-station communications manager 1245 may manage communications with other base stations 105, and may include a controller or scheduler for controlling communications with UEs 115 in cooperation with other base stations 105. For example, the inter-station communications manager 1245 may coordinate scheduling for transmissions to UEs 115 for various interference mitigation techniques such as beamforming or joint transmission. In some examples, the inter-station communications manager 1245 may provide an X2 interface within an LTE/LTE-A wireless communications network technology to provide communication between base stations 105.

The communications manager 1220 may support wireless communication at a base station in accordance with examples as disclosed herein. For example, the communications manager 1220 may be configured as or otherwise support a means for transmitting, to a UE, a set of multiple synchronization signal blocks over a corresponding set of multiple transmission beams. The communications manager 1220 may be configured as or otherwise support a means for receiving, from the UE, an indication of one or more candidate transmission beams for communications between the base station and the UE, where the one or more candidate transmission beams include one or more virtual transmission beams that represent combinations of individual ones of the set of multiple transmission beams. The communications manager 1220 may be configured as or otherwise support a means for selecting a transmission beam from the one or more candidate transmission beams. The communications manager 1220 may be configured as or otherwise support a means for transmitting downlink data to the UE over the transmission beam.

By including or configuring the communications manager 1220 in accordance with examples as described herein, the device 1205 may support techniques for improved communication reliability, reduced latency, improved user experience related to reduced processing, reduced power consumption, more efficient utilization of communication resources, improved coordination between devices, longer battery life, improved utilization of processing capability, or a combination thereof.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of synthesized SSB beams as described herein, or the processor 1240 and the memory 1230 may be otherwise configured to perform or support such operations.

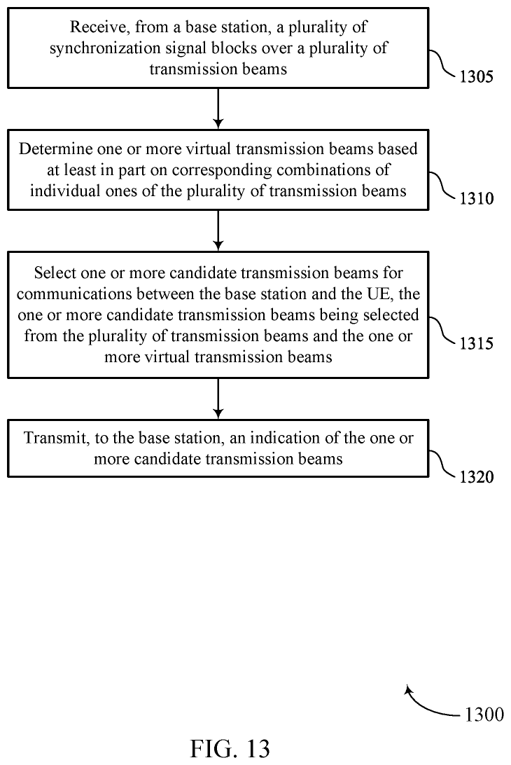

FIG. 13 shows a flowchart illustrating a method 1300 that supports synthesized SSB beams in accordance with examples as disclosed herein. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1305, the method may include receiving, from a base station, a set of multiple synchronization signal blocks over a set of multiple transmission beams. The operations of 1305 may be performed in accordance with examples as disclosed herein. In some examples, aspects of the operations of 1305 may be performed by an SSB reception component 725 as described with reference to FIG. 7.

At 1310, the method may include determining one or more virtual transmission beams based on corresponding combinations of individual ones of the set of multiple transmission beams. The operations of 1310 may be performed in accordance with examples as disclosed herein. In some examples, aspects of the operations of 1310 may be performed by a virtual beam determination component 730 as described with reference to FIG. 7.

At 1315, the method may include selecting one or more candidate transmission beams for communications between the base station and the UE, the one or more candidate transmission beams being selected from the set of multiple transmission beams and the one or more virtual transmission beams. The operations of 1315 may be performed in accordance with examples as disclosed herein. In some examples, aspects of the operations of 1315 may be performed by a candidate beam selection component 735 as described with reference to FIG. 7.

At 1320, the method may include transmitting, to the base station, an indication of the one or more candidate transmission beams. The operations of 1320 may be performed in accordance with examples as disclosed herein. In some examples, aspects of the operations of 1320 may be performed by a candidate beam indication transmission component 740 as described with reference to FIG. 7.

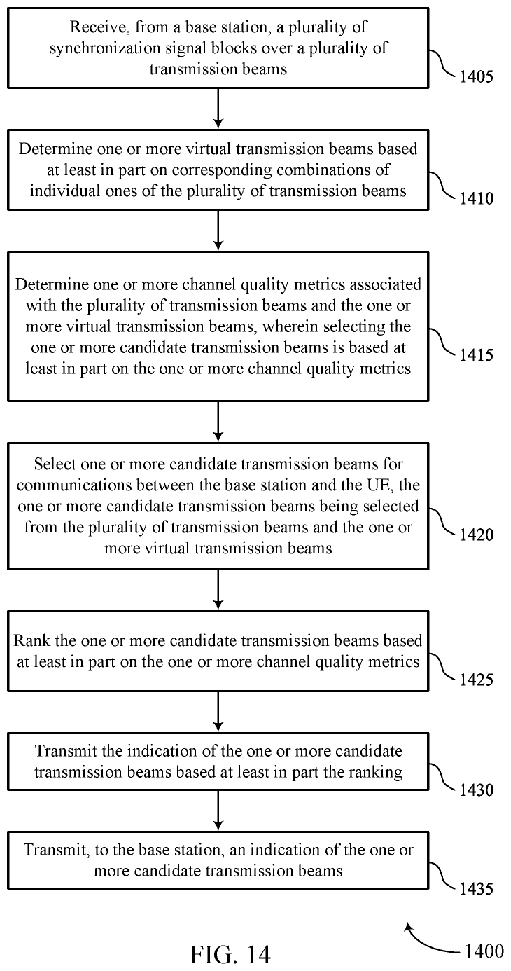

FIG. 14 shows a flowchart illustrating a method 1400 that supports synthesized SSB beams in accordance with examples as disclosed herein. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1405, the method may include receiving, from a base station, a set of multiple synchronization signal blocks over a set of multiple transmission beams. The operations of 1405 may be performed in accordance with examples as disclosed herein. In some examples, aspects of the operations of 1405 may be performed by an SSB reception component 725 as described with reference to FIG. 7.

At 1410, the method may include determining one or more virtual transmission beams based on corresponding combinations of individual ones of the set of multiple transmission beams. The operations of 1410 may be performed in accordance with examples as disclosed herein. In some examples, aspects of the operations of 1410 may be performed by a virtual beam determination component 730 as described with reference to FIG. 7.

At 1415, the method may include determining one or more channel quality metrics associated with the set of multiple transmission beams and the one or more virtual transmission beams, where selecting the one or more candidate transmission beams is based on the one or more channel quality metrics. The operations of 1415 may be performed in accordance with examples as disclosed herein. In some examples, aspects of the operations of 1415 may be performed by a channel metric component 750 as described with reference to FIG. 7.

At 1420, the method may include selecting one or more candidate transmission beams for communications between the base station and the UE, the one or more candidate transmission beams being selected from the set of multiple transmission beams and the one or more virtual transmission beams. The operations of 1420 may be performed in accordance with examples as disclosed herein. In some examples, aspects of the operations of 1420 may be performed by a candidate beam selection component 735 as described with reference to FIG. 7.

At 1425, the method may include ranking the one or more candidate transmission beams based on the one or more channel quality metrics. The operations of 1425 may be performed in accordance with examples as disclosed herein. In some examples, aspects of the operations of 1425 may be performed by a candidate beam selection component 735 as described with reference to FIG. 7.

At 1430, the method may include transmitting the indication of the one or more candidate transmission beams based at least in part on the ranking. The operations of 1430 may be performed in accordance with examples as disclosed herein. In some examples, aspects of the operations of 1430 may be performed by a candidate beam indication transmission component 740 as described with reference to FIG. 7.

At 1435, the method may include transmitting, to the base station, an indication of the one or more candidate transmission beams. The operations of 1435 may be performed in accordance with examples as disclosed herein. In some examples, aspects of the operations of 1435 may be performed by a candidate beam indication transmission component 740 as described with reference to FIG. 7.

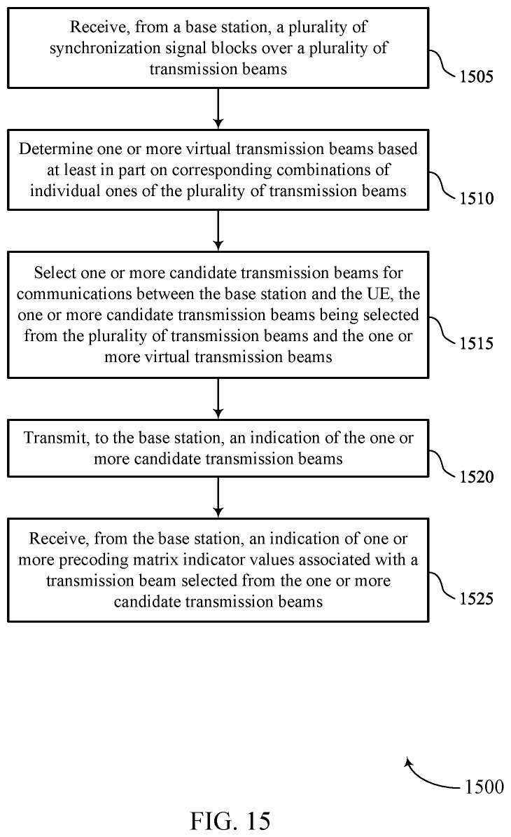

FIG. 15 shows a flowchart illustrating a method 1500 that supports synthesized SSB beams in accordance with examples as disclosed herein. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1505, the method may include receiving, from a base station, a set of multiple synchronization signal blocks over a set of multiple transmission beams. The operations of 1505 may be performed in accordance with examples as disclosed herein. In some examples, aspects of the operations of 1505 may be performed by an SSB reception component 725 as described with reference to FIG. 7.

At 1510, the method may include determining one or more virtual transmission beams based on corresponding combinations of individual ones of the set of multiple transmission beams. The operations of 1510 may be performed in accordance with examples as disclosed herein. In some examples, aspects of the operations of 1510 may be performed by a virtual beam determination component 730 as described with reference to FIG. 7.

At 1515, the method may include selecting one or more candidate transmission beams for communications between the base station and the UE, the one or more candidate transmission beams being selected from the set of multiple transmission beams and the one or more virtual transmission beams. The operations of 1515 may be performed in accordance with examples as disclosed herein. In some examples, aspects of the operations of 1515 may be performed by a candidate beam selection component 735 as described with reference to FIG. 7.

At 1520, the method may include transmitting, to the base station, an indication of the one or more candidate transmission beams. The operations of 1520 may be performed in accordance with examples as disclosed herein. In some examples, aspects of the operations of 1520 may be performed by a candidate beam indication transmission component 740 as described with reference to FIG. 7.

At 1525, the method may include receiving, from the base station, an indication of one or more precoding matrix indicator values associated with a transmission beam selected from the one or more candidate transmission beams. The operations of 1525 may be performed in accordance with examples as disclosed herein. In some examples, aspects of the operations of 1525 may be performed by a PMI reception component 745 as described with reference to FIG. 7.

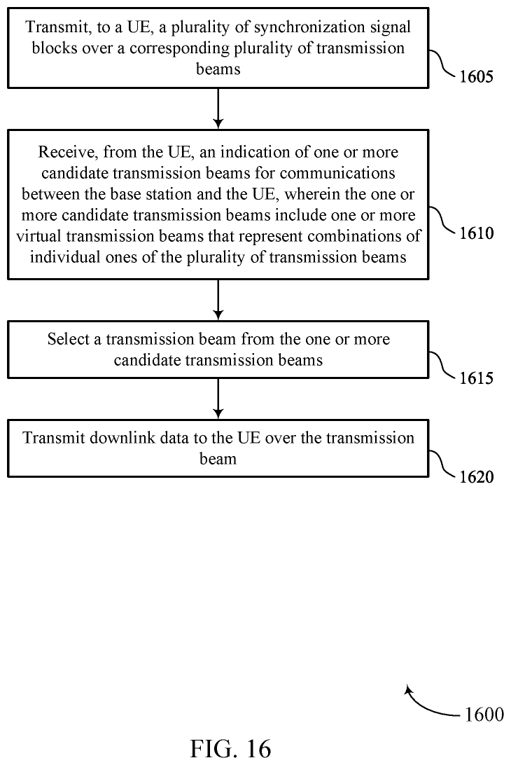

FIG. 16 shows a flowchart illustrating a method 1600 that supports synthesized SSB beams in accordance with examples as disclosed herein. The operations of the method 1600 may be implemented by a base station or its components as described herein. For example, the operations of the method 1600 may be performed by a base station 105 as described with reference to FIGS. 1 through 4 and 9 through 12. In some examples, a base station may execute a set of instructions to control the functional elements of the base station to perform the described functions. Additionally or alternatively, the base station may perform aspects of the described functions using special-purpose hardware.

At 1605, the method may include transmitting, to a UE, a set of multiple synchronization signal blocks over a corresponding set of multiple transmission beams. The operations of 1605 may be performed in accordance with examples as disclosed herein. In some examples, aspects of the operations of 1605 may be performed by an SSB transmission element 1125 as described with reference to FIG. 11.

At 1610, the method may include receiving, from the UE, an indication of one or more candidate transmission beams for communications between the base station and the UE, where the one or more candidate transmission beams include one or more virtual transmission beams that represent combinations of individual ones of the set of multiple transmission beams. The operations of 1610 may be performed in accordance with examples as disclosed herein. In some examples, aspects of the operations of 1610 may be performed by a candidate beam indication reception element 1130 as described with reference to FIG. 11.

At 1615, the method may include selecting a transmission beam from the one or more candidate transmission beams. The operations of 1615 may be performed in accordance with examples as disclosed herein. In some examples, aspects of the operations of 1615 may be performed by a transmission beam selection element 1135 as described with reference to FIG. 11.

At 1620, the method may include transmitting downlink data to the UE over the transmission beam. The operations of 1620 may be performed in accordance with examples as disclosed herein. In some examples, aspects of the operations of 1620 may be performed by a data transmission element 1140 as described with reference to FIG. 11.

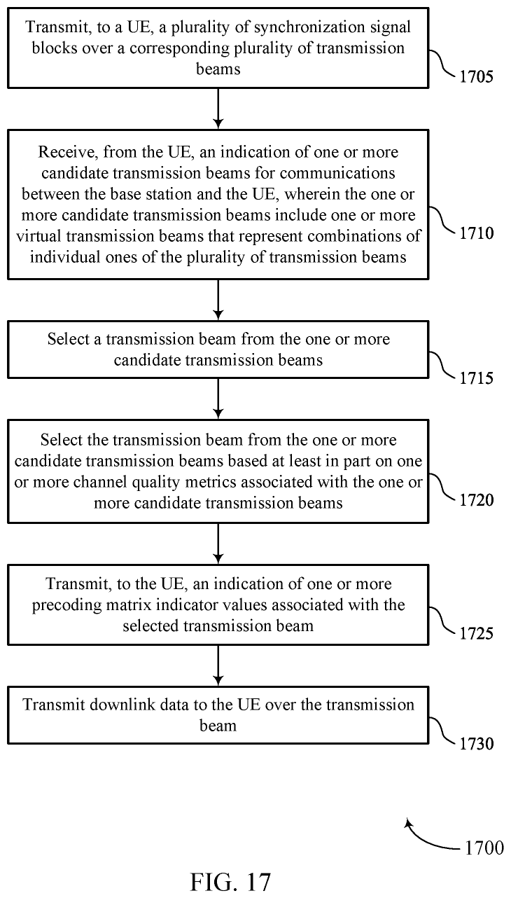

FIG. 17 shows a flowchart illustrating a method 1700 that supports synthesized SSB beams in accordance with examples as disclosed herein. The operations of the method 1700 may be implemented by a base station or its components as described herein. For example, the operations of the method 1700 may be performed by a base station 105 as described with reference to FIGS. 1 through 4 and 9 through 12. In some examples, a base station may execute a set of instructions to control the functional elements of the base station to perform the described functions. Additionally or alternatively, the base station may perform aspects of the described functions using special-purpose hardware.

At 1705, the method may include transmitting, to a UE, a set of multiple synchronization signal blocks over a corresponding set of multiple transmission beams. The operations of 1705 may be performed in accordance with examples as disclosed herein. In some examples, aspects of the operations of 1705 may be performed by an SSB transmission element 1125 as described with reference to FIG. 11.

At 1710, the method may include receiving, from the UE, an indication of one or more candidate transmission beams for communications between the base station and the UE, where the one or more candidate transmission beams include one or more virtual transmission beams that represent combinations of individual ones of the set of multiple transmission beams. The operations of 1710 may be performed in accordance with examples as disclosed herein. In some examples, aspects of the operations of 1710 may be performed by a candidate beam indication reception element 1130 as described with reference to FIG. 11.

At 1715, the method may include selecting a transmission beam from the one or more candidate transmission beams. The operations of 1715 may be performed in accordance with examples as disclosed herein. In some examples, aspects of the operations of 1715 may be performed by a transmission beam selection element 1135 as described with reference to FIG. 11.

At 1720, the method may include selecting the transmission beam from the one or more candidate transmission beams based on one or more channel quality metrics associated with the one or more candidate transmission beams. The operations of 1720 may be performed in accordance with examples as disclosed herein. In some examples, aspects of the operations of 1720 may be performed by a transmission beam selection element 1135 as described with reference to FIG. 11.

At 1725, the method may include transmitting, to the UE, an indication of one or more precoding matrix indicator values associated with the selected transmission beam. The operations of 1725 may be performed in accordance with examples as disclosed herein. In some examples, aspects of the operations of 1725 may be performed by a PMI transmission element 1145 as described with reference to FIG. 11.

At 1730, the method may include transmitting downlink data to the UE over the transmission beam. The operations of 1730 may be performed in accordance with examples as disclosed herein. In some examples, aspects of the operations of 1730 may be performed by a data transmission element 1140 as described with reference to FIG. 11.

The following provides an overview of aspects of the present disclosure:

Aspect 1: A method for wireless communication at a UE, comprising: receiving, from a base station, a plurality of synchronization signal blocks over a plurality of transmission beams; determining one or more virtual transmission beams based at least in part on corresponding combinations of individual ones of the plurality of transmission beams; selecting one or more candidate transmission beams for communications between the base station and the UE, the one or more candidate transmission beams being selected from the plurality of transmission beams and the one or more virtual transmission beams; and transmitting, to the base station, an indication of the one or more candidate transmission beams.

Aspect 2: The method of aspect 1, further comprising: transmitting, to the base station, an indication of one or more virtual transmission beam indices corresponding to the one or more virtual transmission beams based at least in part on one or more indices of the individual ones of the plurality of transmission beams.

Aspect 3: The method of any of aspects 1 through 2, further comprising: receiving, from the base station, an indication of a plurality of precoding matrix indicators associated with the plurality of transmission beams; and determining the one or more virtual transmission beams based at least in part on the plurality of precoding matrix indicators.

Aspect 4: The method of any of aspects 1 through 3, further comprising: determining one or more channel quality metrics associated with the plurality of transmission beams and the one or more virtual transmission beams, wherein selecting the one or more candidate transmission beams is based at least in part on the one or more channel quality metrics; ranking the one or more candidate transmission beams based at least in part on the one or more channel quality metrics; and transmitting the indication of the one or more candidate transmission beams based at least in part on the ranking.

Aspect 5: The method of any of aspects 1 through 4, further comprising: receiving, from the base station, an indication of one or more precoding matrix indicator values associated with a transmission beam selected from the one or more candidate transmission beams.

Aspect 6: The method of aspect 5, further comprising: transmitting, to the base station, an indication of a physical layer security key generated based at least in part on the indication of the one or more precoding matrix indicator values.

Aspect 7: The method of any of aspects 5 through 6, further comprising: receiving an updated indication of the one or more precoding matrix indicator values.

Aspect 8: The method of any of aspects 1 through 7, further comprising: receiving, from the base station, an indication of one or more identifiers associated with the one or more virtual transmission beams; and receiving, from the base station, one or more configurations based at least in part on the one or more identifiers.

Aspect 9: The method of any of aspects 1 through 8, wherein the plurality of synchronization signal blocks are configured based at least in part on a frequency range in which the plurality of synchronization signal blocks are transmitted.

Aspect 10: The method of any of aspects 1 through 9, further comprising: receiving, from the base station, control signaling instructing the UE to determine the one or more virtual transmission beams.

Aspect 11: A method for wireless communication at a base station, comprising: transmitting, to a UE, a plurality of synchronization signal blocks over a corresponding plurality of transmission beams; receiving, from the UE, an indication of one or more candidate transmission beams for communications between the base station and the UE, wherein the one or more candidate transmission beams include one or more virtual transmission beams that represent combinations of individual ones of the plurality of transmission beams; selecting a transmission beam from the one or more candidate transmission beams; and transmitting downlink data to the UE over the transmission beam.

Aspect 12: The method of aspect 11, further comprising: receiving, from the UE, an indication of one or more virtual transmission beam indices corresponding to the one or more virtual transmission beams based at least in part on one or more indices of the individual ones of the plurality of transmission beams.

Aspect 13: The method of any of aspects 11 through 12, further comprising: transmitting, to the UE, an indication of a plurality of precoding matrix indicators associated with the plurality of transmission beams.

Aspect 14: The method of any of aspects 11 through 13, wherein the indication of the one or more candidate transmission beams comprises a ranking of the one or more candidate transmission beams.

Aspect 15: The method of any of aspects 11 through 14, further comprising: selecting the transmission beam from the one or more candidate transmission beams based at least in part on one or more channel quality metrics associated with the one or more candidate transmission beams; and transmitting, to the UE, an indication of one or more precoding matrix indicator values associated with the selected transmission beam.

Aspect 16: The method of aspect 15, further comprising: receiving, from the UE, an indication of a physical layer security key generated based at least in part on the indication of the one or more precoding matrix indicator values.

Aspect 17: The method of any of aspects 15 through 16, further comprising: transmitting, to the UE, an updated indication of the one or more precoding matrix indicator values based at least in part on a change in the one or more channel quality metrics.

Aspect 18: The method of any of aspects 11 through 17, further comprising: transmitting, to the UE, an indication of one or more identifiers associated with the one or more virtual transmission beams; and transmitting, to the UE, one or more configurations based at least in part on the one or more identifiers.

Aspect 19: The method of any of aspects 11 through 18, further comprising: configuring the plurality of synchronization signal blocks based at least in part on a frequency range in which the plurality of synchronization signal blocks are transmitted.

Aspect 20: The method of any of aspects 11 through 19, further comprising: transmitting, to the UE, control signaling instructing the UE to determine the one or more virtual transmission beams.

Aspect 21: An apparatus for wireless communication at a UE, comprising a processor; memory coupled with the processor; and instructions stored in the memory and executable by the processor to cause the apparatus to perform a method of any of aspects 1 through 10.

Aspect 22: An apparatus for wireless communication at a UE, comprising at least one means for performing a method of any of aspects 1 through 10.

Aspect 23: A non-transitory computer-readable medium storing code for wireless communication at a UE, the code comprising instructions executable by a processor to perform a method of any of aspects 1 through 10.

Aspect 24: An apparatus for wireless communication at a base station, comprising a processor; memory coupled with the processor; and instructions stored in the memory and executable by the processor to cause the apparatus to perform a method of any of aspects 11 through 20.

Aspect 25: An apparatus for wireless communication at a base station, comprising at least one means for performing a method of any of aspects 11 through 20.

Aspect 26: A non-transitory computer-readable medium storing code for wireless communication at a base station, the code comprising instructions executable by a processor to perform a method of any of aspects 11 through 20.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving, from a base station, a plurality of synchronization signal blocks over a plurality of transmission beams;
determining one or more virtual transmission beams based at least in part on corresponding combinations of individual ones of the plurality of transmission beams;
selecting one or more candidate transmission beams for communications between the base station and the UE, the one or more candidate transmission beams being selected from the plurality of transmission beams and the one or more virtual transmission beams; and
transmitting, to the base station, an indication of the one or more candidate transmission beams.

2. The method of claim 1, further comprising:
transmitting, to the base station, an indication of one or more virtual transmission beam indices corresponding to the one or more virtual transmission beams based at least in part on one or more indices of the individual ones of the plurality of transmission beams.

3. The method of claim 1, further comprising:
receiving, from the base station, an indication of a plurality of precoding matrix indicators associated with the plurality of transmission beams; and
determining the one or more virtual transmission beams based at least in part on the plurality of precoding matrix indicators.

4. The method of claim 1, further comprising:
determining one or more channel quality metrics associated with the plurality of transmission beams and the one or more virtual transmission beams, wherein selecting the one or more candidate transmission beams is based at least in part on the one or more channel quality metrics;
ranking the one or more candidate transmission beams based at least in part on the one or more channel quality metrics; and
transmitting the indication of the one or more candidate transmission beams based at least in part on the ranking.

5. The method of claim 1, further comprising:
receiving, from the base station, an indication of one or more precoding matrix indicator values associated with a transmission beam selected from the one or more candidate transmission beams.

6. The method of claim 5, further comprising:
transmitting, to the base station, an indication of a physical layer security key generated based at least in part on the indication of the one or more precoding matrix indicator values.

7. The method of claim 5, further comprising:
receiving an updated indication of the one or more precoding matrix indicator values.

8. The method of claim 1, further comprising:
receiving, from the base station, an indication of one or more identifiers associated with the one or more virtual transmission beams; and
receiving, from the base station, one or more configurations based at least in part on the one or more identifiers.

9. The method of claim 1, wherein the plurality of synchronization signal blocks are configured based at least in part on a frequency range in which the plurality of synchronization signal blocks are transmitted.

10. The method of claim 1, further comprising:
receiving, from the base station, control signaling instructing the UE to determine the one or more virtual transmission beams.

11. A method for wireless communication at a base station, comprising:
transmitting, to a user equipment (UE), a plurality of synchronization signal blocks over a corresponding plurality of transmission beams;
receiving, from the UE, an indication of one or more candidate transmission beams for communications between the base station and the UE, wherein the one or more candidate transmission beams include one or more virtual transmission beams that represent combinations of individual ones of the plurality of transmission beams;
selecting a transmission beam from the one or more candidate transmission beams; and
transmitting downlink data to the UE over the transmission beam.

12. The method of claim 11, further comprising:
receiving, from the UE, an indication of one or more virtual transmission beam indices corresponding to the one or more virtual transmission beams based at least in part on one or more indices of the individual ones of the plurality of transmission beams.

13. The method of claim 11, further comprising:
transmitting, to the UE, an indication of a plurality of precoding matrix indicators associated with the plurality of transmission beams.

14. The method of claim 11, wherein the indication of the one or more candidate transmission beams comprises a ranking of the one or more candidate transmission beams.

15. The method of claim 11, further comprising:
selecting the transmission beam from the one or more candidate transmission beams based at least in part on one or more channel quality metrics associated with the one or more candidate transmission beams; and
transmitting, to the UE, an indication of one or more precoding matrix indicator values associated with the selected transmission beam.

16. The method of claim 15, further comprising:
receiving, from the UE, an indication of a physical layer security key generated based at least in part on the indication of the one or more precoding matrix indicator values.

17. The method of claim 15, further comprising:
transmitting, to the UE, an updated indication of the one or more precoding matrix indicator values based at least in part on a change in the one or more channel quality metrics.

18. The method of claim 11, further comprising:
transmitting, to the UE, an indication of one or more identifiers associated with the one or more virtual transmission beams; and
transmitting, to the UE, one or more configurations based at least in part on the one or more identifiers.

19. The method of claim 11, further comprising:
configuring the plurality of synchronization signal blocks based at least in part on a frequency range in which the plurality of synchronization signal blocks are transmitted.

20. The method of claim 11, further comprising:
transmitting, to the UE, control signaling instructing the UE to determine the one or more virtual transmission beams.

21. An apparatus for wireless communication at a user equipment (UE), comprising:
a processor;
memory coupled with the processor; and
instructions stored in the memory and executable by the processor to cause the apparatus to:
receive, from a base station, a plurality of synchronization signal blocks over a plurality of transmission beams;
determine one or more virtual transmission beams based at least in part on corresponding combinations of individual ones of the plurality of transmission beams;
select one or more candidate transmission beams for communications between the base station and the UE, the one or more candidate transmission beams being selected from the plurality of transmission beams and the one or more virtual transmission beams; and
transmit, to the base station, an indication of the one or more candidate transmission beams.

22. The apparatus of claim 21, wherein the instructions are further executable by the processor to cause the apparatus to:
transmit, to the base station, an indication of one or more virtual transmission beam indices corresponding to the one or more virtual transmission beams based at least in part on one or more indices of the individual ones of the plurality of transmission beams.

23. The apparatus of claim 21, wherein the instructions are further executable by the processor to cause the apparatus to:
receive, from the base station, an indication of a plurality of precoding matrix indicators associated with the plurality of transmission beams; and
determine the one or more virtual transmission beams based at least in part on the plurality of precoding matrix indicators.

24. The apparatus of claim 21, wherein the instructions are further executable by the processor to cause the apparatus to:
determine one or more channel quality metrics associated with the plurality of transmission beams and the one or more virtual transmission beams, wherein selecting the one or more candidate transmission beams is based at least in part on the one or more channel quality metrics;
rank the one or more candidate transmission beams based at least in part on the one or more channel quality metrics; and
transmit the indication of the one or more candidate transmission beams based at least in part on the ranking.

25. The apparatus of claim 21, wherein the instructions are further executable by the processor to cause the apparatus to:
receive, from the base station, an indication of one or more precoding matrix indicator values associated with a transmission beam selected from the one or more candidate transmission beams.

26. An apparatus for wireless communication at a base station, comprising:
a processor;
memory coupled with the processor; and
instructions stored in the memory and executable by the processor to cause the apparatus to:
transmit, to a user equipment (UE), a plurality of synchronization signal blocks over a corresponding plurality of transmission beams;
receive, from the UE, an indication of one or more candidate transmission beams for communications between the base station and the UE, wherein the one or more candidate transmission beams include one or more virtual transmission beams that represent combinations of individual ones of the plurality of transmission beams;
select a transmission beam from the one or more candidate transmission beams; and
transmit downlink data to the UE over the transmission beam.

27. The apparatus of claim 26, wherein the instructions are further executable by the processor to cause the apparatus to:
receive, from the UE, an indication of one or more virtual transmission beam indices corresponding to the one or more virtual transmission beams based at least in part on one or more indices of the individual ones of the plurality of transmission beams.

28. The apparatus of claim 26, wherein the instructions are further executable by the processor to cause the apparatus to:
transmit, to the UE, an indication of a plurality of precoding matrix indicators associated with the plurality of transmission beams.

29. The apparatus of claim 26, wherein the indication of the one or more candidate transmission beams comprises a ranking of the one or more candidate transmission beams.

30. The apparatus of claim 26, wherein the instructions are further executable by the processor to cause the apparatus to:
select the transmission beam from the one or more candidate transmission beams based at least in part on one or more channel quality metrics associated with the one or more candidate transmission beams; and
transmit, to the UE, an indication of one or more precoding matrix indicator values associated with the selected transmission beam.
